(19) United States
(12) Patent Application Publication
(10) Pub. No.: US 2005/0098333 A1
(43) Pub. Date: May 12, 2005

(54) Air valve of pneumatic motor of screwdriver and air path of the air valve

(76) Inventor: Yun-Chung Lee, Taipei Hsien (TW)

Correspondence Address: Yun-Chung Lee, 235 Chung-Ho, Box 8-24, Taipei, TW

(21) Appl. No.: 10/705,509

(22) Filed: Nov. 12, 2003

(51) Int. Cl. B25D 9/00

(52) U.S. Cl. 173/104; 173/93

(57) ABSTRACT

An air valve of a pneumatic motor of a screwdriver and an air path of the air valve is disclosed. A spindle of the pneumatic motor is formed with a bi-directional rod groove. One end of the rod groove is communicated to an air inlet of the pneumatic motor and another end thereof is formed with a valve gate to be communicated to an air supply in the screwdriver so as to form an air path to supply air to drive the pneumatic motor. A piston rod for beating a screw nail is mounted in the rod groove. An air stop washer is formed on the piston rod for controlling opening and closing of the valve gate with the movement of the screw nail as the screw nail is beaten so as to control the opening and closing of the valve gate. Thus rotation of the pneumatic motor is controlled.

### FIELD OF THE INVENTION

The present invention relates to screwdrivers, and particularly to an air valve of a pneumatic motor of a screwdriver and an air path of the air valve, wherein a motor air path is formed between an air inlet of a pneumatic motor and an air supply of the screwdriver. A piston rod is also used in the screwdriver for rotating the screw nail to be beaten into a work piece.

### BACKGROUND OF THE INVENTION

The pneumatic screwdriver is actuated by high pressure air to drive a piston rod in the cylinder to generate linear dynamic power and drive a pneumatic motor in the screwdriver to rotate. Then dynamic power is transferred to the screw nail locking rod to beat the screw nail to a work piece.

In general, the prior art screwdriver has a cylinder. The application of the piston, and pneumatic motor are known in the prior art. Generally, in this prior art, the pneumatic motor is installed above the cylinder and the piston rod, and separates from the piston rod. Moreover, a curved air path is formed at the lateral wall of the air inlet end of the pneumatic motor and is communicated to an air valve at a lower end of the cylinder wall. By linearly reciprocal movement of the piston rod, the air path of the motor is controlled to open or close so as to drive the piston rod to cause the screw nail to move linearly and rotate.

However, in above prior art, the spindle of the motor is a solid spindle. It only has a function of transferring rotary power. Moreover, the curved air path formed at the lateral wall of the air inlet end of the pneumatic motor has larger curvatures. This is not beneficial to the reduction of the volume of the screwdriver and smoothness of high-pressure air transferring to the pneumatic motor. These defects are also disclosed in many prior arts.

### SUMMARY OF THE INVENTION

Accordingly, the primary object of the present invention is to provide an air valve of a pneumatic motor of a screwdriver and an air path of the air valve, wherein the air path is in the motor spindle communicated between the air inlet of the pneumatic motor and the air supply of the screwdriver. The air path is shorter and is at a centerline of the structure of the screwdriver. Thereby, a preferred stability is retained.

Another object of the present invention is to provide an air valve of a pneumatic motor of a screwdriver and an air path of the air valve, wherein one end of a piston rod in the air path of the pneumatic motor is formed as a valve rod to open or close the air path of the motor so as to reduce the space for assembling the air valve of the pneumatic motor.

A further object of the present invention is to provide an air valve of a pneumatic motor of a screwdriver and an air path of the air valve, wherein an air inlet channel is communicated to an air inlet of the pneumatic motor. When the upper valve opening of the main air valve is opened, high pressure air can be smoothly supplied to the air path of the pneumatic motor.

To achieve above objects, the present invention provides an air valve of a pneumatic motor of a screwdriver and an air path of the air valve. A spindle of the pneumatic motor is formed with a bidirectional rod groove. One end of the rod groove is communicated to an air inlet of the pneumatic motor and another end thereof is formed with a valve gate to be communicated to an air supply in the screwdriver so as to form an air path to supply air to drive the pneumatic motor. A piston rod for beating a screw nail is mounted in the rod groove. An air stop washer is formed on the piston rod for controlling opening and closing of the valve gate with the movement of the screw nail as the screw nail is beaten so as to control the opening and closing of the valve gate. Thus rotation of the pneumatic motor is controlled.

The various objects and advantages of the present invention will be more readily understood from the following detailed description when read in conjunction with the appended drawing.

### BRIEF DESCRIPTION OF THE DRAWINGS

FIG. 1 is a perspective view of the screwdriver of the present invention.

FIG. 2 is a schematic view of the head of the screwdriver of the present invention.

FIG. 3 is a cross sectional view showing the condition before pressing the trigger according to the present invention.

FIG. 4 is a cross sectional view showing the initial condition of pressing the trigger according to the present invention.

FIG. 5 is a cross sectional view showing the condition after the trigger is pressed and before the piston rod moves forwards.

FIG. 6 is a cross sectional view showing the condition after the trigger is pressed and before the piston rod moves forwards to an extreme position.

FIG. 7 is a cross sectional view showing a condition that the trigger is released and the piston rod returns.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

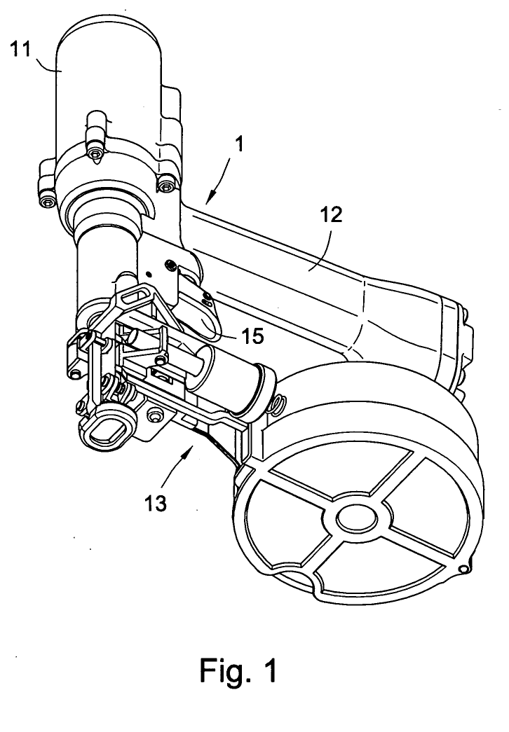

With reference to FIG. 1, the perspective view of the pneumatic screwdriver of the present invention is illustrated. The screwdriver mainly includes a head 11 and a handle 12 which are formed as a screwdriver body 1. A lower end of the screwdriver body 1 is installed with a screw nail driver 13 for driving screw nails so as to pushing the screw nails to a nail beating position. A bottom of the screwdriver body is installed with a trigger 15. Thereby, the user can trigger the trigger 15 for driving the screw nail in the screwdriver body to a work piece.

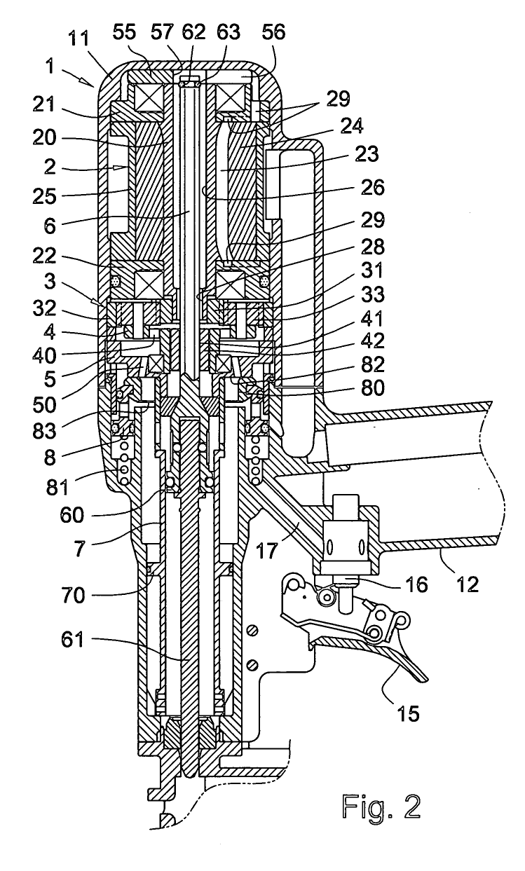

With reference to FIG. 2, the interior and the driving structure of the pneumatic screwdriver of the present invention are illustrated. The structure comprises the following elements.

A pneumatic motor 2 has a spindle 20 at a central axis of the motor so as to install the pneumatic motor 2 between a bearing top seat 21 and a bearing bottom seat 22. A plurality of radiating blade grooves 23 are formed in the pneumatic motor 2 for receiving a plurality of blades 24. The blades are driven in an eccentric housing 25 by high-pressure air for driving the spindle 20.

The bearing top seat 21 and bearing bottom seat 22 are formed with air inlets 29, respectively so as to communicate the blade groove 23. A top of the bearing top seat 21 is installed with a washer 55. The washer 55 has at least one groove portion 56 which extends from the inner hole 57. The groove portion 56 is communicated to the air inlet 29 so as to form an air input path of the motor.

A rod groove 26 is formed within the spindle 20 of the motor. One end of the rod groove 26 is communicated to the air input path of the pneumatic motor 2 and another end thereof is formed with a neck-like valve opening 28 with a smaller inner diameter and is communicated to an air supply within the screwdriver body (will be described hereinafter). Thereby, an air path for guiding high-pressure air to drive the pneumatic motor 2 is formed.

A planet gear set 3 has a driving gear 31. The driving gear 31 is driven by the spindle 20 and then serves to drive a plurality of driven gears 33 around the driving gear 31 and an internal gear 32.

The driven gears 33 will drive a power output disk 4 on the bearing seat 5 to rotate. An axial line of the output disk 4 is formed with a polygonal hole 41 and a polygonal piston rod 6 is installed along an axial line of the output disk 4 and passes through the polygonal hole 41. Or a bush 42 is engaged to the polygonal hole 41 and then the piston rod 6 is enclosed by the bush 42. A plurality of disk holes 40 may be formed on the output disk 4, which is communicated to the valve opening 28 of the rod groove 26.

A plurality of seat holes 50 are formed on the bearing seat 5. The seat holes 50 are communicated to the rod groove 26 and the valve opening 28. A lower end of the bearing seat 5 is formed with a cylinder 7. An outer wall of the cylinder 7 is formed with an isolating ring 70. A main air valve 8 and a main air valve gate 80 are mounted between the bearing seat 5 and the cylinder 7. Two ends of the main air valve gates 80 have an upper valve opening 82 and a lower valve opening 83, respectively. A spring 81 resists against a lower end of the main air valve 8.

The polygonal wall of the piston rod 6 is engaged to the power output disk 4 to be driven to rotate and the piston rod 6 passes through the valve opening 28 so as to be hidden in the rod groove 26 of the spindle 20 of the motor. Thereby, other than being as a central path of airflow in the air path of the motor, the rod groove 26 serves for receiving the piston rod 6.

A lower end of above piston rod 6 has a piston valve 60 which is movably installed in the cylinder 7. A lower end of the piston rod 6 is buckled with a screw nail locking rod 61. Moreover, a top of the piston rod 6 is installed with an annular groove 62. An air stop washer 63 is installed in the annular groove 62 so as to be formed as a valve rod for controlling the opening and closing of the neck-like valve opening 28 in the air path of the motor.

Furthermore, in the present invention, the air supply path communicated to the valve opening 28 of the rod groove 26 is formed by the disk hole 40 on the output disk 4, the seat hole 50 of the bearing seat 5, the upper valve opening 82 of the main air valve gate 80, etc.

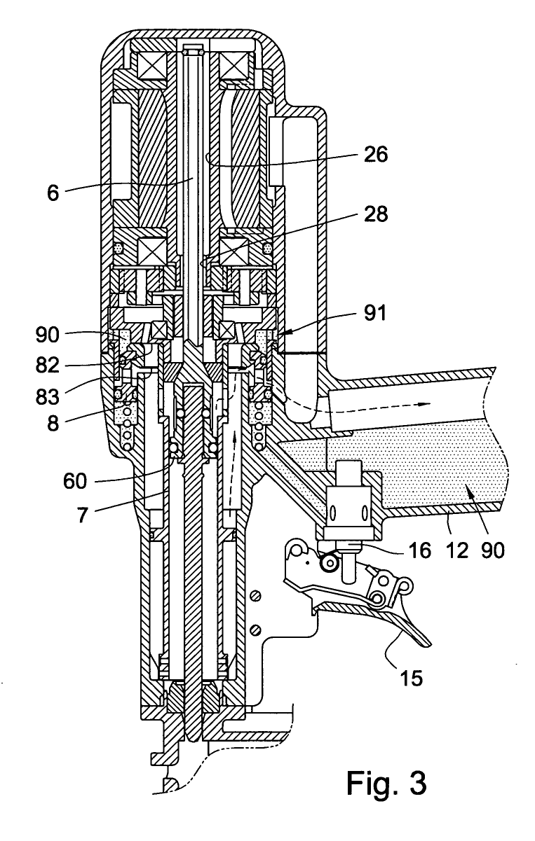

When the user dose not trigger the trigger 15 (referring to FIG. 3), the upper valve opening of the main air valve gate 80 is closed. The high-pressure air 90 in the top air chamber 91 can not flow into the upper valve opening 82. Therefore, the pneumatic motor 2 cannot rotate. At this time, the lower valve opening 83 of the main air valve gate 80 is opened. The air at the top of the piston valve 60 will release out so that the piston rod 6 returns to the top and is hidden within the rod groove 26.

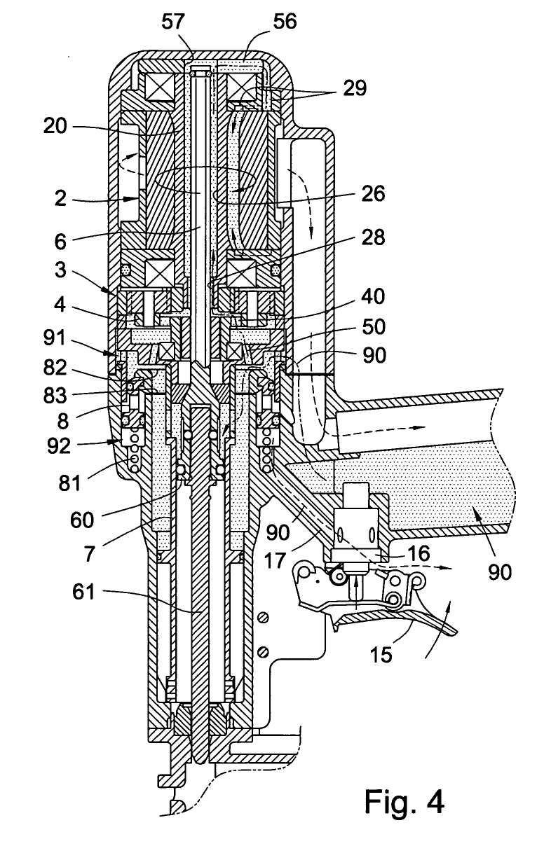

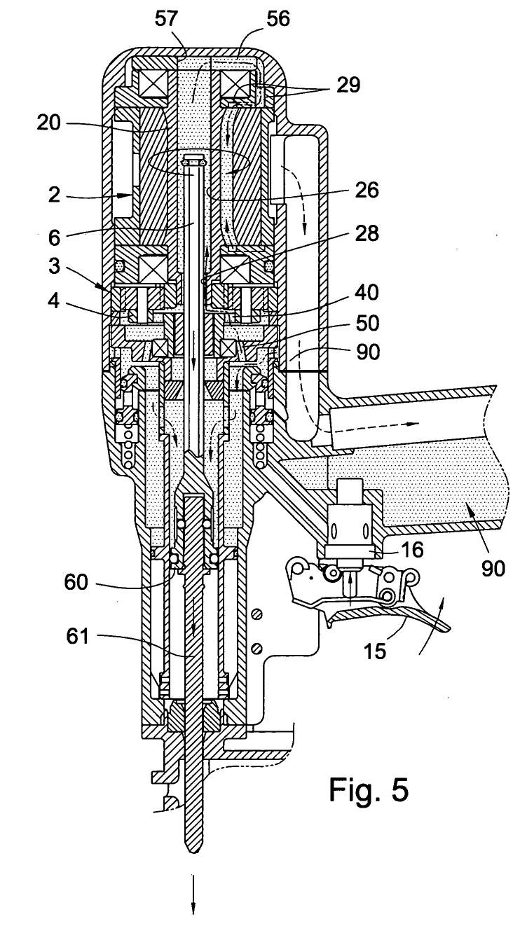

When the user presses, the trigger 15 (referring to FIG. 4), the trigger valve 16 is opened so that the air exhausting path from the trigger air channel 17 to outside is opened. Thereby, high pressure air 90 in the middle layer air channel 92 releases out. Then, high pressure air continuously supplies to the top layer air channel 91 of the main air valve 8. As a consequent, the air pressure induced is larger than the pressure from the spring 81 of the middle layer air channel 92 so as to open the upper valve opening 82 and to close the lower valve opening 83. High-pressure air 90 will enter into the cylinder 12 from the upper valve opening 82 to the piston 7 to push the piston valve 60. Thereby, the piston rod 6 moves linearly to drive the screw nail locking rod 61 to descend rapidly (referring to FIG. 5). Furthermore, high-pressure air 90 enters into the disk hole 40 and the seat hole 50 communicated to the valve opening 28, and enters into the rod groove 26 of the air path of the motor. Then air flows to the inner hole 57, groove portion 56, air inlet 29, etc. of the air path of the motor to drive the spindle 20 of the pneumatic motor 2 to generate rotation power so as to drive the planet gear set 3 and the output disk 4 to rotate. Thereby, the descending piston rod 6 is driven to rotate so that the screw nail locking rod 61 to rotate the screw nail.

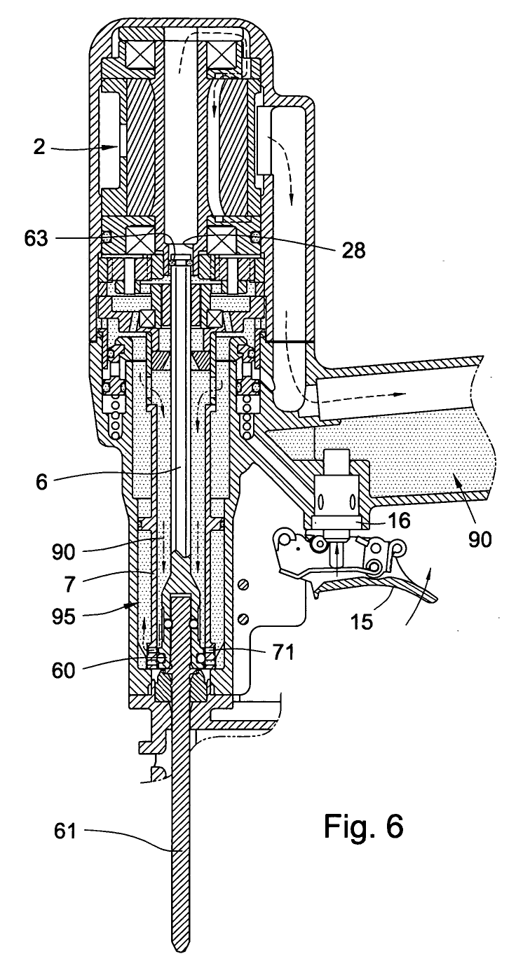

When the piston rod 6 descends to a bottom (referring to FIG. 6), high pressure air 90 in the cylindrical main body and at the top portion of the piston valve 60 is guided to a returning air chamber 95 through a guide hole 71 near a lower end of the cylinder 7. At this moment, the screw nail is embedded, the air stop washer 63 on the piston rod 6 has been descended to close the valve opening 28 and isolates air supplying path and air input end of the motor so that the pneumatic motor 2 stops.

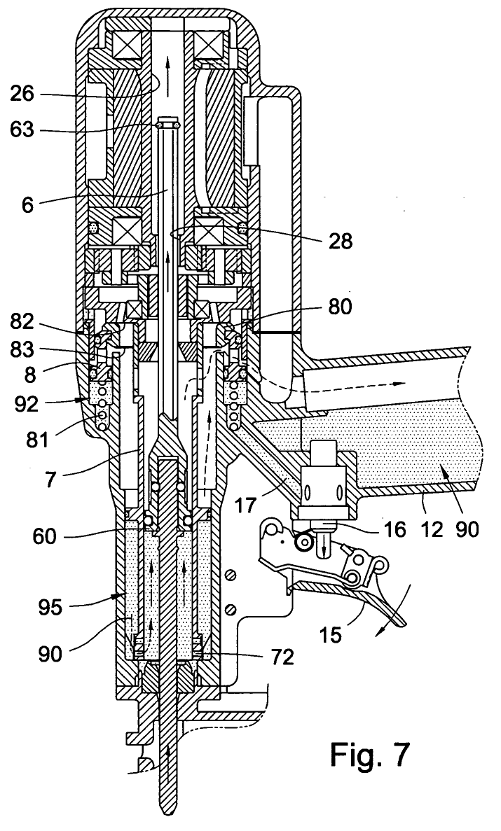

Then, when the user releases the trigger 15 and releases the trigger valve 16 (referring to FIG. 7), the trigger valve 16 will close the air exhausting path from trigger air channel 17 to outside. The high pressure air 90 in the handle 12 flows through the trigger air channel 17 to enter into the middle layer air channel 92 for building pressure. With the resilient force of the spring 81, the main air valve gate 80 of the main air valve 8 returns for closing upper valve opening 82 to isolate the air from flowing to the valve opening 28 and the air stop washer 63. Moreover, the lower valve opening 83 is opened for releasing air in the cylinder 7. Thereby, high pressure air 90 accumulating in the returning air chamber 95 is guided into the cylinder 7 at the bottom of the piston valve 60 from the guide hole 72 to push the piston rod 6 to move upwards and thus to be hidden in the rod groove 26 (referring to FIG. 3).

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1-3. (canceled)

4. An air valve structure of a pneumatic motor of a screwdriver, a spindle of a pneumatic motor being installed between a bearing top seat and a bearing bottom seat; the bearing top seat being installed in a top of an inner chamber of the screwdriver with a top washer being located between the bearing top seat and a top wall of the inner chamber; each of the bearing top seat and the bearing bottom seat having a respective air inlet for driving the pneumatic motor to rotate; wherein
the spindle of the pneumatic motor is formed with a bi-directional rod groove; one top end of the rod groove is communicated to the top of the inner chamber with an air inlet of the pneumatic motor and a bottom end thereof is formed with a valve gate to be communicated to an air supply of an upper valve opening of the valve gate in the screwdriver so as to form an air path to supply air to drive the pneumatic motor,
a piston rod for beating a screw nail is mounted in the rod groove; an air stop washer is formed on the piston rod for controlling opening and closing of the valve gate with the movement of the screw nail as the screw nail is beaten so as to control the opening and closing of the valve gate, and thus rotation of the pneumatic motor is controlled.

5. The air valve structure of a pneumatic motor of a screwdriver as claimed in claim 1, wherein the air inlet of the pneumatic motor has an annular washer at a top of the bearing top seat; the annular washer has a groove which is extended from an inner hole of the annular washer to outsides so as to communicated with rod groove and the air inlet of the pneumatic motor.

6. The air valve structure of a pneumatic motor of a screwdriver as claimed in claim 1, wherein a planet gear set has a first driving gear; the first driving gear is driven by the spindle and then serves to drive a plurality of second driven gears around the first driving gear and an internal gear; the second driven gears will drive a power output disk on the bearing seat to rotate.

7. The air valve structure of a pneumatic motor of a screwdriver as claimed in claim 1, wherein an axial line of the output disk 4 is formed with a polygonal hole and a polygonal piston rod is installed along an axial line of the output disk and passes through the polygonal hole.

8. The air valve structure of a pneumatic motor of a screwdriver as claimed in claim 1, wherein a bush is engaged to the polygonal hole and then the piston rod is enclosed by the bush; a plurality of disk holes are formed on the output disk, which is communicated to a valve opening of the rod groove.
